(19) United States
(12) Patent Application Publication
(10) Pub. No.: US 2024/0401247 A1
(43) Pub. Date: Dec. 5, 2024

(54) RESORBABLE AND BIOCOMPATIBLE GLASS FIBER BUNDLE HAVING A WELL-DEFINED DIAMETER AND PROCESS FOR MAKING SUCH

(71) Applicant: PURAC BIOCHEM B.V, GORINCHEM (NL)

(72) Inventors: Jenq LIU, Tucker, GA (US); Judit CANADELL-AYATS, Gorinchem (NL); Muhammed Sami HASAN, Tucker, GA (US); Shawn James PENISTON, Tucker, GA (US)

(21) Appl. No.: 18/806,670

(22) Filed: Aug. 15, 2024

Related U.S. Application Data
(63) Continuation of application No. PCT/EP2023/053933, filed on Feb. 16, 2023.
(60) Provisional application No. 63/310,776, filed on Feb. 16, 2022.

(30) Foreign Application Priority Data
Feb. 25, 2022 (EP) 22158898.1

(51) Int. Cl. D02G 3/18; C03B 37/02; C03B 37/083; C03C 3/097; C03C 4/00; C03C 13/00; C03C 25/26; C08K 7/14; D02G 3/44

(52) U.S. Cl. CPC D02G 3/18; C03B 37/02; C03B 37/083; C03C 3/097; C03C 4/0014; C03C 13/00; C03C 25/26; C08K 7/14; D02G 3/447; D02G 3/448; C03C 2204/00; C03C 2213/02; C08K 2201/003; D10B 2401/063; D10B 2401/12; D10B 2505/02; D10B 2509/00

(57) ABSTRACT

The invention relates to a resorbable and biocompatible glass fiber bundle characterized in that the glass fibers of the bundle have an average diameter in the range of 5-30 μm, as measured according to ASTM D1577-01 C, the glass fiber bundle having a coefficient of variation at most 15%. The invention also pertains to, and a method of obtaining this glass fiber bundle. Also, the invention relates to composites and medical devices produced with said glass fiber bundle.

### RELATED APPLICATIONS

This application is a continuation of International PCT Application PCT/EP2023/053933 filed Feb. 16, 2023, which application claims priority to European Patent Application No. 22158898.1 filed Feb. 25, 2022, and U.S. Provisional Patent Application No. 63/310,776 filed Feb. 16, 2022, the entire contents of which are incorporated herein by reference.

### FIELD OF THE INVENTION

The invention is in the field of resorbable and biocompatible glass fiber bundles and medical devices comprising glass fiber bundles for mechanical reinforcement. The invention further extends to methods of making said glass fiber bundles.

### BACKGROUND

Glass fibers are used in many and diverse areas of technology including insulation, wind energy, data transmission and reinforced materials. In the latter field, the glass fibers are embedded in thermoplastic or thermoset polymer to form a composite. These composites are extensively used for sports, automotive and medical applications, and in the latter field there are again many subfields where glass fibers are used, including manufacturing of durable, impact resistant materials that combine relatively light-weight with high stiffness and strength, and excellent dimensional stability.

Although composite materials have been around in medicine and dentistry for over 50 years, for example hydroxyapatite composite resin, fiber-reinforced orthopedic implants, and more recently carbon fiber-reinforced dental implants, the field of fully resorbable composites materials constitutes a new class of materials. Such composites can be produced to be biocompatible and resorbable, and thus contain a glass fiber which is biocompatible and resorbable as well, such as a glass fiber as disclosed in EP 2243749. These biocompatible and resorbable materials can be used for implants that disintegrate and are resorbed according to a controlled rate. This allows producing implants that do not have to be removed from the body and thus do not need a second surgery.

Although glass has been produced by mankind for centuries, manufacturing high quality, continuous glass fibers remains an active field of research. The quality of the end product requires careful control of the raw materials and the production process. For glasses which are to be used in fully resorbable composites for biomedical applications and which are hence resorbable and biocompatible glasses, this is of particular importance.

Conventionally, glass fibers are produced as follows. Glass is produced as the first step. Suitable raw materials are heated to temperatures ranging from 1100° C. to 1500° C. and are transformed through a sequence of heat treatments and chemical reactions between the various metal oxides, hydroxides and/or carbonates into molten glass. Typically, the molten glass is then divided into smaller portions and left to solidify to form small glass chips, chunks or marbles and stored for further use.

In order to produce the glass fibers, the glass chips, chunks or marbles are delivered to an electrically heated bushing comprising an array of tipped orifices. The bushing is made of a precious metal alloy and the temperature is accurately controlled for control over the viscosity of the glass melt. The glass is molten and subsequently allowed to flow through the bushing under gravity to come out of the bushing tips as attenuated glass fibers. The fibers are left to solidify and commonly wound on a core to produce a bobbin with fiber.

U.S. Pat. No. 4,738,701 discloses a glass fiber forming assembly which permits rapid change of a production fiber glass bushing. The system includes a secondary bushing and means to heat it as well as a glass delivery bushing permanently connected to a forehearth. The production bushings are physically out of contact with the forehearth. This assembly only allows just one bushing at a time to be positioned adjacent to the glass passing tubes of the forehearth.

There is a need for an improved method for producing resorbable and biocompatible glass fibers that are more refined in that relatively thin fibers can be produced, which fibers preferably have a more even diameter in the sense that the coefficient of variation of the fiber diameter is low.

### SUMMARY OF THE INVENTION

It has now been found that relatively thin glass fibers, preferably with an even fiber diameter, can be produced in a controlled fashion involving a method with a two-staged bushing design. The use of two consecutive bushings makes it possible to attenuate thin fibers from a melt, producing fibers which are low in defects and air bubbles. This leads to the formation of a high quality glass fiber bundle with small diameter fibers with an even fiber diameter. The even fiber diameter is evidenced by a low coefficient of variation over the fiber diameter. It also leads to a stable process, resulting in a stable diameter over time.

First, cold glass chips, chunks or marbles are molten in the first bushing. The first bushing is provided with a plurality of orifices, and the molten glass flows through the plurality of orifices and is collected in the second bushing.

Subsequently, the melt is withdrawn from the second bushing though a plurality of orifices, to make fibers of desired diameter and letting the glass melt stream solidify to obtain the glass fiber bundle.

Using this new method, a new resorbable, biocompatible, and preferably bioactive glass fiber bundle can be produced, specifically, a resorbable and biocompatible glass fiber bundle characterized in that the glass fibers of the bundle have an average diameter in the range of 5-30 μm, wherein the glass fiber bundle has a coefficient of variation of at most 15%.

The glass fiber bundles of the present invention, and the glass fibers from the bundles can also be used in medical devices.

These glass fiber bundles and the glass fibers from the bundles are especially suitable for production of biocompatible, resorbable and preferably bioactive composites for use in the manufacturing of medical devices. In such a composite, glass fiber bundles according to the invention, or glass fibers from said bundles, are coated with and/or embedded in a polymer matrix, optionally after having been provided with a sizing composition which treatment renders them more compatible with the surrounding, resorbable polymer.

### DETAILED DESCRIPTION

The present invention relates to a resorbable and biocompatible glass fiber bundle, sometimes indicated as yarn, which is characterized in that the individual glass fibers in the bundle have an average diameter of 5-30 μm. Preferably the individual glass fibers—sometimes called filaments—have an average diameter of 6-25 μm, more preferably 6-20 μm, more preferably 7-20 μm, and even more preferably 8-15 μm. It is clear that the ranges also include the respective end points, i.e., average diameter of 5, 6, 7, 8, 15, 20, 25 and 30 μm. The term glass fiber bundle herein is used in its normal meaning and refers to a collection of individual glass fibers which are aligned, and which are somehow held together in close proximity. A glass fiber bundle is generally obtained in a single attenuation step. It is possible to combine fiber bundles from different attenuation steps to form a cord. It is also possible to split a fiber bundle from a single attenuation step into a number of bundles. It is understood that a bundle of glass fibers may be produced according to the method of the invention using a two-staged bushing design. A glass fiber bundle according to the invention may consequently mean a collection of glass fibers directly obtained or obtainable by the method, without a step of fiber selection being performed.

It is noted that the method of the present invention makes it possible to obtain a glass fiber bundle in which the individual glass fibers are relatively thin, i.e. have a diameter of at most or below 30 μm, in particular at most or below 25 μm, more in particular at most or below 20 μm in some embodiments at most or below 15 μm, and where the bundle has a low coefficient of variation by the two-step bushing method described below. Without wishing to be bound by theory, it is believed that the use of two bushings as described below results in a more homogeneous glass melt and less air bubbles in the glass melt, and therefore less voids in the fibers, which in turn results in less fiber breakage.

The coefficient of variation of the diameter of the glass fibers in the glass fiber bundle is at most 15%, in particular at most 10%. The coefficient of variation may be at most 8%, or at most 6%. It has been found that in some embodiments the coefficient of variation may be at most 3%, which is a measure of a very even diameter indeed. The coefficient of variation is determined as follows: For 30 individual glass fibers from a glass fiber bundle, the diameter is determined. The average diameter and the standard deviation are calculated. The coefficient of variation is the standard deviation divided by the average diameter, expressed in %

A glass fiber bundle according to the invention preferably has at least 50 fibers, preferably at least 100, more preferably at least 150, and even more preferably at least 200 fibers. As a maximum, a value of 5000 fibers may be mentioned, more in particular 3000.

The glass fiber bundle according to the invention preferably has a linear density of between 20 and 1300 tex, in particular between 50 and 500 tex for the total bundle, preferably between 70 and 300 tex, as measured according to ASTM D1577-01 A. The term linear density corresponds to the weight of a certain length of the glass fiber bundle and the unit tex corresponds to the weight in grams per 1000 meters of fiber.

Glass is always made up of different ingredients. These are often divided into three categories: 1) network formers, 2) network modifiers and 3) intermediates. Network formers, which are the major components of glass, refers to a class of ingredients that forms the highly cross-linked backbone network that gives the glass most of its properties. Network modifiers refers to a class of ingredients that can be added to tweak the physical properties of the glass to meet certain specifications. Network modifiers usually reduce glass network connectivity. Then there are also ingredients that can take part in the glass network and from there tweak the glass properties. These ingredients belong to the class of intermediates.

The glass fiber bundle according to the invention preferably has glass fibers that are composed of a glass composition comprising network formers and network modifiers, wherein the molar ratio between the network formers and network modifiers is between 1 and 4, preferably between 1.5 and 3.5, more preferably between 2 and 3. It has been observed that ratios according such a range, and in particular one of the preferred ranges leads to a good glass quality, which is particularly suitable for fiber formation.

The glass fibers preferably comprise network formers which are selected from oxides of silicon, such as silica (SiO₂), oxides of boron, such as diboron trioxide (B₂O₃) and boron suboxide (B₆O), and oxides of phosphorous, such as phosphorous trioxide (P₂O₃) and phosphorus pentoxide (P₂O₅ or P₄O₁₀). The glass fibers preferably comprise network modifiers which are selected from oxides of sodium, such as Na₂O or Na₂O₂, oxides of magnesium, such as MgO, and oxides of calcium, such as CaO.

More preferably, the glass fibers comprise several network formers and several network modifiers. The glass fibers preferably have a composition comprising
50-75 wt. % of SiO₂, in particular 55-75 wt. %, more in particular 60-75 wt. %,
0-15 wt. % of B₂O₃,
0.5-5 wt. % of P₂O₅, in particular 0.5-4 wt. %, more in particular 0.5-3 wt. %,
5-20 wt. % of Na₂O,
0-25 wt. % of CaO, in particular 2-25 wt. %, more in particular 5-25 wt. %.
0-10 wt. % of MgO,
0-1 wt. % of Li₂O,
0-15 wt. % of K₂O, in particular 0-10 wt. %, more in particular 0-4 wt. %,
0-4 wt. % of SrO,
0-5 wt. % of Al₂O₃, and
0-5 wt. % of Fe₂O₃.

In one embodiment, the glass fibers have a composition comprising 60-75 wt. % of SiO₂, 0-15 wt. % of B₂O₃, 0.5-3 wt. % of P₂O₅, 5-20 wt. % of Na₂O, 5-25 wt. % of CaO, 0-10 wt. % of MgO, 0-1 wt. % of Li₂O, 0-4 wt. % of K₂O, 0-4 wt. % of SrO, 0-5 wt. % of Al₂O₃, and 0-5 wt. % of Fe₂O₃.

In one embodiment, the glass composition comprises less than 10 wt. % of B₂O₃, in particular less than 5 wt. %. In one embodiment, the glass composition comprises 7-20 wt. % Na₂O. In one embodiment, the glass composition comprises 2-8 wt. % MgO. In one embodiment, the glass composition comprises 5-15 wt. % CaO.

The glass fibers of the present invention preferably are radiopaque, meaning that they are not transparent to X-rays. It is understood that X-rays refers to high-energy radiation having a wavelength from about 10 μm to 10 nm. The use of radiopaque glass fibers is particularly attractive in composites for implantable medical devices because it allows monitoring of the degradation of the composite through X-ray in-vivo.

The glass fibers preferably have a tensile strength of 1000-3000 MPa, preferably between 1200-2500 MPa, more preferably 1400-2200 MPa, as measured by tensile testing according to DIN EN ISO 5079.

The glass fibers in the glass fiber bundle according to the invention preferably have an elastic modulus between 20-100 GPa, preferably between 35-85 GPa, more preferably between 50-70 GPa as measured by tensile testing according to DIN EN ISO 5079 “Determination of breaking force and elongation at break of individual fibres” (ISO 5079:2020).

The glass composition in the glass fibers (and glass fiber bundle) preferably has a liquidus temperature as measured according to ASTM C829-81 (2015) of at least 800° C., in particular at least 830° C., more in particular at least 860° C. The liquidus temperature is generally at most 1000° C., in particular at most 950° C., in particular at most 910° C.

In one embodiment the glass composition melt exhibits a working window ΔT=TF−TL<330° C., wherein TF is the fiber forming temperature at log(η) of 3.0 dPas and TL is the liquidus temperature of the glass composition, specifically <280° C., more specifically <260° C. In particular, it has been found that the method of the present invention makes it possible to obtain relatively thin glass fibers from compositions with a relatively narrow working window.

The invention further provides a method to produce a glass fiber bundle in a controlled fashion using a two-staged bushing design. In particular, the glass is refined in two separated stages to create a melt with less defects than a glass produced with a single bushing stage. These defects include air bubbles which can be seen as voids in the solid glass using an optical microscope. Also, fibers with air bubbles are more prone to breaking, which can be seen during production as well as in laboratory tensile tests. Hence, in other words, the glass produced with the two-staged design will form higher quality small diameter fibers compared to the single-bushing design. This results in the formation of glass fiber bundles wherein the glass fibers of the bundle have an average diameter in the range of 5-30 μm, as measured according to ASTM D1577-01 C, and the glass fiber bundle has a coefficient of variation at most 15%. The preferences on the properties of the glass fiber bundle and the glass fiber expressed above also apply to the glass fiber bundle as produced by the method of the present invention, and the fibers present therein. The preferences expressed above for the composition of the glass also apply to the glass used in the method, and to the glass fiber bundle and glass fibers present therein which are obtained through the method.

The invention hence provides for a method for obtaining a glass fiber bundle, comprising the steps of:
a) providing a resorbable and biocompatible glass composition melt,
b) providing the glass composition melt to a first bushing having a plurality of orifices,
c) allowing or forcing the glass composition melt to flow through the orifices of the first bushing, producing an intermediate glass melt stream,
d) collecting the intermediate glass melt stream in a second bushing having a plurality of orifices, and allowing or forcing the intermediate glass melt stream through the orifices of the second bushing to obtain a second glass melt stream, and
e) attenuating the second glass melt stream from the orifices of the second bushing to obtain glass fibers and letting the glass melt stream solidify to obtain a glass fiber bundle.

After the glass fiber bundle is obtained, it is preferably collected using a suitable apparatus. Preferably it is collected by winding the glass fiber bundle onto a cylindrical cone.

In the first stage of the method, cold glass chips, chunks or marbles are molten in the first bushing to prepare the melt. The first bushing in provided with a plurality of orifices. In general, the number or orifices is in the range of 2 to 5000, in particular 10 to 5000, in particular in the range of 10 to 2000, more in particular 20 to 2000. The orifices generally have a diameter in the range of 0.05 mm to 5 mm. In the first bushing, the melt generally is at a temperature of 1000-1500° C., more preferably of 1100-1400° C. and even more preferably 1250-1380° C., more in particular 1250-1350° C.

It is preferred that the viscosity of the melt in the first bushing is not higher than 2000 poise, as determined using DIN ISO 7884 1998-02, preferably not higher than 1000 poise, and more preferably not higher than 850 poise, or 750 poise. A relatively low viscosity helps to let entrapped 5 air escape. As a lower limit, a value of 80 poise, in particular 100 poise may be mentioned. It may be preferred for the viscosity in the first bushing to be in the range of 100-500 poise, in particular 100-500 poise.

The glass composition in the first bushing is allowed or forced to flow through the orifices of the first bushing, to produce an intermediate glass melt stream, which is collected in a second bushing. The second bushing is provided with a plurality of orifices. In general, the number or orifices is in the range of 10 to 5000, in particular in the range of 20 to 2000. The orifices generally have a diameter in the range of 0.05 mm to 5 mm. In the second bushing, the melt generally is at a temperature of from 1100 to 1250° C.

It is preferred that the melt in the second bushing has a viscosity not higher than 2000 poise, as determined using DIN ISO 7884 1998-02, preferably not higher than 1000 poise, and more preferably not higher than 850 poise. However, the viscosity is preferably at least 300 poise, more preferably at least 500 poise, and even more preferably at least 750 poise, in order to allow for a stable melt spinning process. In one embodiment the glass melt has a viscosity at liquidus temperature (TL) and at the fiber forming temperature that is higher than the lower limit of the fiberizing viscosity window.

In general, the temperature of the second bushing will be lower than the temperature of the first bushing. This is because the first bushing is operated at a temperature which generates a low-viscosity melt, from which air can easily escape while the second bushing provides a melt suitable for fiber manufacture, which requires a lower temperature. Preferably the difference between the temperature of the second bushing and the first bushing is at least 50° C., preferably at least 100° C., and more preferably at least 150° C.

Analogously, in general, the viscosity of the melt in the first bushing will generally be between 50 and 800 poise below the fiber forming temperature viscosity in the second bushing. The viscosity of the melt in the first bushing may for instance be between 100 and 600 poise lower than that of the melt in the second bushing, preferably between 200 and 400 poise lower than that of the melt in the second bushing, more preferably between 250 and 350 poise lower than that of the melt in the second bushing, such as 310 or 320 poise lower than that of the melt in the second bushing.

It may be preferred for the diameter of the orifices of the second bushing to be smaller than the diameter of the orifices of the first bushing. This is because the orifices in the second bushing are intended to provide thin glass fibers, while the orifices in the first bushing are intended just to pass the glass melt.

The homogeneity of the melt and the removal of air or gas from the glass melt may be improved by passing the intermediate glass melt stream in a thin film over a plate between the first and second bushing. This provides a high surface area for the glass melt, and additional residence time, both of which will improve the degassing. The plate may be provided as a separate piece of equipment, or it may be present in the top of the second bushing, upstream of the orifices of the second bushing and/or below and downstream of the orifices in the first bushing. The thin film may be open in that the melt is provided on a carrier plate. It is also possible to provide the thin film between a carrier plate and a top plate. This intermediate film-forming step leads to additional deairing or degassing of the glass melt. It may be preferred for the film forming step to be carried out at a temperature which is the same as or higher than the temperature of the first bushing.

The glass melt in the second bushing is allowed or forced through the orifices of the second bushing to obtain a second glass melt stream, and the second glass melt stream from the orifices of the second bushing is attenuated to obtain fibers, followed by letting the glass melt stream solidify to obtain the glass fiber bundle. These latter steps are conventional in the art, and require no further elucidation.

In one embodiment, the method according to the invention further comprises splitting the glass fiber bundle into at least two parts. This may be attractive as it allows the weight and linear density of the glass fiber bundle to be selected more precisely.

In one embodiment, the fibers of the glass fiber bundle are provided with a sizing. Sizing is well-known in the art of glass fiber manufacture. It is the process of treating a fiber, in the present case a glass fiber, with a surface-modifying composition. A sizing may comprise various additives, such as plasticizers, film-forming polymers, or lubricants. In one embodiment, a sizing is applied which comprises a thermoplastic, resorbable and biocompatible polymer for example a polyester, which is more preferably covalently bonded to the glass fiber through a coupling agent with at least one silane moiety. One reason to apply a sizing on a glass fiber that is to be incorporated into a composite with a matrix polymer is to improve the interfacial adhesion of the glass fibers with the matrix polymer by improving the compatibility of the surface of the—generally essentially hydrophilic—glass with a hydrophobic-matrix polymer that is in contact with the surface of the glass. Typically, the glass fibers are provided with a sizing layer to lower surface energy. For the concept of compatibility, this sizing layer is considered an integral part of the glass fiber. As a result, a sized glass fiber that is compatible with the matrix polymer layer means that the sizing layer is compatible with the matrix polymer, and thus provides good interfacial adhesion for load-transfer and proper distribution of fibers in the matrix polymer. Hence, in a preferred embodiment the resorbable glass fibers compatible with the matrix polymer are resorbable glass fibers, having a sizing layer on their surface that is compatible with the matrix polymer. An attractive sizing and method for its application are described in a patent application with the same applicant filing date and priority date as the present application, with the title “Resorbable glass fiber coated with a sizing and method for preparing such”, the text of which is incorporated herein by reference in its entirety. Further sizing compositions are known in the art, and require no further elucidation here.

The glass fiber bundle according to the invention, and the glass fibers present therein are suitable for use in many applications. In one embodiment, the glass fiber bundle, or fibers originating from the bundle, are used in medical devices, such as orthopedic implants. Examples of orthopedic implants include bone fixation devices, intramedullary nails, joint (hip, knee, elbow) implants, spine implants, and other devices for such applications such as for fracture fixation, tendon reattachment, spinal fixation, and spinal cages. Examples of bone fixation devices include screws, plates, rods, tapes, nails, wires, pin wires, anchors, cables, ties, or wire ties, plate and screw systems, and external fixators. The coated glass fibers or the composite of the present invention can also be used in tissue engineering for example in woven and non-woven fabrics and scaffolds. Hence the present invention also pertains to the use of the glass fiber bundle and the glass fibers in medical devices, and to medical devises comprising the composite as described herein.

The present invention also pertains to a composite comprising the glass fiber bundle as described herein, or the glass fibers derived from such a bundle, in a polymer matrix. In particular, the polymer matrix is biocompatible and/or biodegradable. In the composite, the glass fibers or glass fiber bundles may be present as continuous fibers and/or a chopped fibers. Chopped fibers, if used, generally have a length in the range of 1 mm to 50 mm, in particular 1 mm to 25 mm, more in particular 1 mm to 20 mm, even more in particular 2 mm to 10 mm, most in particular below 4 mm. The invention also pertains to a medical device comprising the composite.

Accordingly, in one embodiment, the invention pertains to a composite comprising glass fibers from one or more glass fiber bundles according to the invention, in a polymer matrix, compatible with the glass fibers, wherein the glass fibers and the polymer matrix are preferably biocompatible and resorbable and more preferably bioactive. As is well known in the art, a bioactive material is a material that has been designed to elicit or modulate biological activity. Bioactive material is often surface-active material that is able to chemically bond with the mammalian tissues. Bioactive glass may further be designed to leach ions or other chemicals resulting in osteoconductive, osteoinductive, anti-infective and/or angiogenic benefits.

Examples of suitable polymer matrix materials include polymers selected from the group of polylactides (PLA), poly-L-lactide (PLLA), poly-DL-lactide (PDLA), L-lactide/DL-lactide copolymers (PLDLA), polyglycolide (PGA), poly(ε-caprolactone) (PCL), copolymers of glycolide, copolymers of ε-caprolactone, copolymers of lactide, glycolide/trimethylene carbonate copolymers (PGA/TMC), lactide/tetramethylglycolide copolymers, lactide/trimethylene carbonate copolymers, lactide/δ-valerolactone copolymers, lactide/8-caprolactone copolymers, glycolide/lactide copolymers (PGLA), lactide/glycolide/trimethylene carbonate terpolymers, lactide/glycolide/ε-caprolactone terpolymers, PLA/polyethylene oxide copolymers, unsymmetrically 3,6-substituted poly-1,4-dioxane-2,5-diones, polyhydroxybutyrates (PHB), PHB/β-hydroxyvalerate copolymers (PHB/PHV), poly-β-hydroxypropionate (PHPA), poly-p-dioxanone (PDO) poly-δ-valerolactone-poly-ε-caprolactone, poly(ε-caprolactone-DL-lactide) copolymers, polyesters of oxalic acid, poly-β-malic acid (PMLA), poly-β-alkanoic acids, and mixtures thereof. The use of matrix polymers selected from the group of polylactide, poly(lactide-co-glycolide), poly(lactide-co-ε-caprolactone), polyglycolide (PGA), and poly(ε-caprolactone) (PCL) may be particularly preferred.

Preferably, the composite has a glass fiber content, calculated on the total of glass and polymer of between 5 and 95 wt. %, preferably between 10 and 90 wt. %, more preferably between 15 and 80 wt. %, even more preferably between 20 and 70 wt. %, most preferably between 30 and 60 wt. %. Alternatively, the composite preferably has a glass fiber content of at least 60 wt. %, more preferably at least 70 wt. %, even more preferably at least 80 wt. % and even more preferably at least 90 wt. %.

The composite according to the invention may comprise further components in addition to glass fiber (bundles) and polymer, e.g., up to 30 wt. %, up to 20 wt. %, or up to 10 wt. %. Examples of further components may be hydroxy-apatite and calcium phosphate, such as tricalciumphosphates (TCP), e.g. β-TCP. It may be preferred for the composite to comprise an additive, for instance an active pharmaceutical ingredient (API) or a mineral ingredient, embedded within the composite.

The invention also pertains to a medical device comprising the glass fiber bundles according to the present invention or the composite according to the invention. An attractive composite is described in a patent application with the same applicant, inventors, and filing date as the present application, with the title “Biocompatible and resorbable polymer composite material and method for obtaining such”, the text of which is incorporated herein by reference in its entirety.

In one embodiment, the medical device comprises a unidirectional composite tape. Glass-fiber-based tapes are known in the art. They comprise a biodegradable polymer and a plurality of unidirectionally aligned continuous glass fibers, with the fibers being aligned in the length direction of a tape. The tape generally has a width which is at least 2 times the thickness of the tapes, in particular at least 5 times, more in particular at least 10 times. The length of the tape generally is at least 10 times the width of the tape, in particular at least 100 times. The thickness of the tape is preferably less than 0.3 mm, more preferably less than 0.2 mm and even more preferably less than 0.15 mm. The length of the tape is preferably at least 1 m, more preferably at least 5 m, and even more preferably at least 10 m. The third dimension (i.e. the width) is preferably between 0.5 and 10 cm, more preferably between 0.8 and 5 cm, and even more preferably between 1 and 2.5 cm. Composite tapes can be obtained, e.g., by spreading the fibers of a glass fiber bundle, contacting the glass fibers with a polymer matrix in the liquid phase, and solidifying the matrix. Unidirectional composite tapes preferably have a matrix content of 2-40 wt. %, in particular 5-30 wt. %, more in particular 5-25 wt. %, in specific embodiments 10-20 wt. %. The preferences given elsewhere for the nature of the matrix and the nature of the glass fiber also apply here.

In one embodiment, the medical device comprises a plurality of layers, each layer comprising a composite tape.

Thus, in one embodiment, the composite is shaped in the form of an unidirectional composite tape, as discussed above. In an alternative embodiment, the composite material is shaped as a strand, (cannulated) rod, tube, pellet, or granule. A strand/rod is a round-shaped fiber reinforced polymer with a diameter that is preferably between 5-50 mm. Pellets are small length-wise sections of a rod having a diameter of about 5-50 mm and granules are small particles having a diameter of about 1-10 mm. The dimensions of the pellets or granules may be adapted to match the dimensions of feeding screws used in polymer processing techniques, for example injection molding.

In the composite and the medical device, the glass fiber (bundles) are preferably sized glass fiber (bundles).

As will be evident to the skilled person, different embodiments of the present invention can be combined unless they are mutually exclusive.

All percentages used herein are weight percentages, unless specified otherwise.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

The invention will be elucidated with reference to the following examples, without being limited thereto or thereby.

### EXAMPLES

### Measurements

### Average Fiber Diameter

The average fiber diameter of the glass fibers in the fiber bundle is measured according to ASTM D1577-01 C

### X-Ray Fluorescence (XRF)

XRF analysis of glass elements was performed according to DIN 51001:2003-8.

### X-Ray Diffraction (XRD)

XRD analysis of amorphous content was performed according to ASTM F1538-03.

### Glass Fiber Bundle Weight

Glass fiber bundle weight was determined according to ASTM D1577-01, option A, using a ILE Yarn Reel, for which one rotation of the steel reel is equal to 1 meter of fiber.

### Linear Density and Fiber Diameter

Linear density was determined according to ASTM D1577-01, option C-1, using a Textechno Favimat. This method is based on a string vibration technique, in which gauge length and pre-tensioning force can be controlled and the resonance frequency can be determined to then provide the linear density and diameter values of that fiber. The calculation used by the Favimat to 25 determine linear density is:

$${T}_{t} = \frac{{F}_{v} \cdot {10}^{4}}{4 {( fL )}^{2}}$$

wherein:
Tₜ=linear density [dtex]
Fᵥ=pre-tensioning force [cN]
f=resonance frequency [Hz]
L=gauge length [mm]

The fiber diameter can be calculated from the linear density Tₜ using:

$${T}_{t} = ( \frac{π ρ}{100} ) ( \frac{d}{2} ) 2$$

wherein:
ρ=relative density of fiber/polymer [g/cm3]
d=fiber diameter [μm]

### Coefficient of Variation

The coefficient of variation is determined as follows: For 30 glass fibers in a glass fiber bundle, the diameter is determined. The average diameter and the standard deviation are calculated. The coefficient of variation is the standard deviation divided by the average diameter, expressed in 10%.

### Liquidus Temperature

The liquidus temperature measurement was performed according to ASTM C829-81 (2015).

### Viscosity

Viscosity (n) was measured according to DIN ISO 7884 1998-02, “Glass-Viscosity and viscometric fixed points-Part 2: Determination of viscosity by means of rotation viscometers”.

### Glass Fiber Tensile Strength

A tensile test is run to determine the strength, elastic modulus, and maximum elongation of the fiber. The single fiber tensile measurements were conducted at room temperature of 23° C. using a Textechno Favimat apparatus equipped with a 210 cN load cell. The tensile test was carried out in accordance with DIN EN ISO 5079. The gauge length was 20 mm and the test velocity 5 mm/min.

### Example 1

Raw materials (sand, sodium carbonate, calcium carbonate, magnesium carbonate, sodium tetraborate and calcium hydrogen phosphate dihydrate) were collected in a platinum crucible and subsequently melted in a furnace before being annealed, crushed, remolten and again annealed to obtain a bioactive, resorbable and biocompatible glass composition. This glass composition was cooled to obtain glass chips containing 68.5 wt. % of SiO₂, 1.5 wt. % of P₂O₅, 2.1 wt. % of B₂O₃, 13.8 wt. % of Na₂O, 4.7 wt. % of MgO, 9.2 wt. % of CaO, 0.1 wt. % of Al₂O₃, 0.022 wt. % of Fe₂O₃, 0.008 wt. % of K₂O and 0.011 wt. % of TiO₂, based on an average of three XRF-measurements.

### Example 2

Part of the glass chips obtained in Example 1 were loaded into a glass hopper, and fed into a first bushing, maintained at a temperature of 1288° C., where they were molten. The molten glass was passed through the orifices of the first bushing. The glass melt was then passed onto a plate where it was spread in a thin film which resulted in a homogeneous and degassed glass composition. The thin film of molten glass was provided to the top of a second bushing. The second bushing was maintained at a temperature at a value of 1137 to 1193° C., as specified in in Table 1 below for the various experiments. The second bushing was provided with a base plate with 576 individual orifices, through which the molten glass was formed into a glass fiber bundle, which is wound of filaments with a winder with the collet diameter of 8 inches (203 mm). A sizing solution was applied to the filaments of the glass fiber bundle using sizing applicator roller, and the bundle was collected on a rotating core.

The fiber bundle weight and fiber diameter of the glass fiber were determined and are shown in Table 1. As can be seen, adjustment of the collet winding speed and the temperature in the second bushing, and thereby glass viscosity, allowed for manipulation of the fiber diameter. At the constant temperature, the faster the pull speed, the smaller the fiber diameter that results.

TABLE 1
Glass fiber diameter of different winding conditions.

| | Fibers | | Winding | | Average fiber | Coefficient |
|---|---|---|---|---|---|---|
| | per | Temperature | speed | Fiber bundle | Diameter | of variation |
| Number | bundle | (° C.) | (rpm) | weight (Tex) | (μm) | (%) |
| A | 576 | 1137 | 550 | 152 | 11.2 | 4.5 |
| B | 576 | 1182 | 450 | 267 | 16.1 | 4.3 |
| C | 576 | 1193 | 550 | 394 | 18.3 | 1.6 |
| D | 576 | 1190 | 1300 | 99 | 9.3 | 4.8 |
| E | 576 | 1190 | 2000 | 85 | 8.4 | 5.3 |

### Comparative Example A

Another portion of the glass pellets obtained in Example 1 were loaded into a glass hopper, and fed into a single bushing, maintained at a temperature of 1150° C. The bushing had 204 individual orifices, through which the molten glass is formed into a glass fiber bundle, which is wound with a winder with the collet diameter of 8 inches (203 mm). A sizing solution was applied to the fibers of the glass fiber bundle using sizing applicator roller, and the bundle was collected on a rotating collector.

The melt obtained was observed to be less homogeneous than the melt in Example 2. The glass fibers obtained show much more melt defects (e.g. crystals, air bubbles). The fiber bundle weight was 66 tex. The fiber diameter was 11.2 micron. The coefficient of variation was 21.4%. From this data it can be seen that the process of the invention, in which two bushings are used, leads to a fiber with a more even diameter, as evidenced by a lower coefficient of variation, than a comparable process in which a single bushing is used.

### Example 3

Example 2 was repeated, except that after collecting the fiber on a core according to Example 2, the fiber bundle as obtained in Example 2 was instead collected on two or three separate cores, positioned side by side, to produce bundles with a lower fiber bundle weight. Fiber bundle weight, single fiber diameter, tensile strength and elastic modulus (including standard deviations) were measured and are shown in Table 2. Data for the non-split sample FL-004 from Table 1 are also included.

TABLE 2
Glass fiber diameter of different winding conditions.

| | | | | Fiber | Single fiber | Coefficient | | |
|---|---|---|---|---|---|---|---|---|
| | Fibers | | Winding | bundle | diameter | of | Tensile | Elastic |
| | per | T | speed | weight | average | variation | strength | modulus |
| | bundle | (° C.) | (rpm) | (Tex) | (μm) | (%) | (MPa) | (GPa) |
| No split | 576 | 1182 | 450 | 267 ± 24 | 16.1 ± 0.7 | 4.3 | 1502 ± 570* | 65.5 ± 0.2 |
| bundle | | | | | | | | |
| B | | | | | | | | |
| Split 2 | 288 | 1176 | 500 | 148.2 ± 5.8 | 16.7 ± 0.9 | 5.3 | 1438 ± 172 | 66 ± 0.2 |
| Bundle | | | | | | | | |
| Split 3 | 192 | 1176 | 500 | 96 ± 2.5 | 16.1 ± 0.8 | 4.9 | 1698 ± 251 | 65.6 ± 0.2 |
| Bundle | | | | | | | | |

*the standard deviation for the tensile strength is relatively high. This is believed to be due to issues with the application of the sizing.

### Example 4

This example is intended to show that the method of the present invention makes it possible to obtain bundles of relatively thin fibers from glass compositions which have a relatively narrow working window.

For three glass compositions, the liquidus temperature and the fiber forming temperature were determined. The working window, which is the temperature difference (ΔT) between the liquidus temperature TL and the fiber forming temperature TF at a log(η) of 2.8 dPas were also calculated. The data are given in Table 3 below.

TABLE 3
Temperature data on three glass compositions

| | | Fiber forming | |
|---|---|---|---|
| | Liquidus | temperature (T_{F}) | |
| | temperature (T_{L}) | at log(η) = 2.8 | |
| Glass Sample | (° C.) | (° C.) | ΔT (° C.) |
| GL001 | 860.0 | 1180.2 | 320.2 |
| GL002 | 910.0 | 1168.8 | 258.7 |
| GL003 | 889.0 | 1159.7 | 270.7 |

Fibers were manufactured from these compositions using the process of the present invention, analogous to the process described in Example 2. It was found that for all compositions it was possible to obtain bundles of 500-600 high quality fibers with an average diameter in the range of 6 to 30 microns.

What is claimed is:

1. A resorbable and biocompatible glass fiber bundle, wherein the glass fibers of the glass fiber bundle have an average diameter in the range of 5-30 μm, wherein the coefficient of variation of the diameter is at most 15%, and wherein the number of fibers in the glass fiber bundle is at least 50.

2. The glass fiber bundle according to claim 1, wherein the glass fibers in the glass fiber bundle comprise:
50 to 75 wt. % of SiO₂,
0 to 15 wt. % of B₂O₃,
0.5 to 5 wt. % of P₂O₅,
5 to 20 wt. % of Na₂O,
5 to 25 wt. % of CaO,
0 to 10 wt. % of MgO,
0 to 1 wt. % of Li₂O,
0 to 15 wt. % of K₂O,
0 to 4 wt. % of SrO,
0 to 5 wt. % of Al₂O₃, and
0 to 5 wt. % of Fe₂O₃.

3. The glass fiber bundle according to claim 1, wherein the glass fibers have a tensile strength of 1000-3000 MPa as measured according to DIN EN ISO 5079, and/or wherein the glass fibers have an elastic modulus between 20 GPa and 100 GPa as measured according to DIN EN ISO 5079.

4. A method for obtaining a glass fiber bundle, comprising the steps of:
a) providing a resorbable and biocompatible glass composition melt,
b) providing the glass composition melt to a first bushing having a plurality of orifices,
c) allowing or forcing the glass composition melt to flow through orifices of the first bushing, producing an intermediate glass melt stream,
d) collecting the intermediate glass melt stream in a second bushing having a plurality of orifices, and allowing or forcing the intermediate glass melt stream through the orifices of the second bushing to obtain a second glass melt stream, and
e) attenuating the second glass melt stream from the orifices of the second bushing to obtain fibers and letting the glass melt stream solidify to obtain a glass fiber bundle.

5. The method according to claim 4, wherein the temperature in the first bushing is in the range of 1000 to 1500° C., and wherein the temperature in the second bushing is in the range of from 1100 to 1250° C.

6. The method according to claim 5, wherein the second bushing is operated at a temperature which is lower than the temperature of the first bushing, wherein the difference between the temperature of the second bushing and the temperature of the first bushing is at least 50° C.

7. The method according to claim 4, wherein viscosity of the melt in the first bushing is at least 50 poise below viscosity of the melt in the second bushing.

8. The method according to claim 4, wherein the intermediate glass melt stream resulting from the orifices of the first bushing is passed in a thin film over a plate before being provided to the second bushing.

9. The method according to claim 8, wherein the temperature of the glass in the thin film is higher than the temperature of the glass in the first bushing.

10. The method according to claim 4, further comprising splitting the glass bundle into at least two bundles, and/or applying a sizing onto the glass fiber bundle(s), and/or collecting the glass fiber bundle(s).

11. A composite comprising the glass fiber bundle obtained by the method of claim 4, or glass fibers from said bundle, in a polymer matrix compatible with the glass fibers, wherein the glass fibers and the polymer matrix are (i) biocompatible and resorbable, (ii) bioactive, or (i) and (ii).

12. The composite according to claim 11, wherein the composite in the form of a unidirectional composite tape, tape, strand, (cannulated) rod, tube, pellet, or granule.

13. A medical device comprising the composite of claim 11.

14. A composite comprising the glass fiber bundle according to claim 1, or glass fibers from said bundle, in a polymer matrix compatible with the glass fibers, wherein the glass fibers and the polymer matrix are (i) biocompatible and resorbable, (ii) bioactive, or (i) and (ii).

15. The composite according to claim 14, wherein the composite in the form of a unidirectional composite tape, tape, strand, (cannulated) rod, tube, pellet, or granule.

16. A medical device comprising the composite of claim 14.

17. The glass fiber bundle according to claim 1, wherein the glass fibers are composed of a glass formulation comprising network formers and network modifiers, wherein the weight or molar ratio between the network formers and network modifiers is between 1 and 4, and wherein the network former comprises an oxide of Si, B, P, Na, Mg, or Ca.

18. The glass fiber bundle according to claim 1, wherein the glass fibers are sized glass fibers, wherein the glass fibers are made of a glass with a liquidus temperature of at least 800° C. as measured according to ASTM C829-81 (2015), and/or wherein the bundle has a linear density of between 50 and 500 tex as measured according to ASTM D1577-01 A.

19. The glass fiber bundle according to claim 1, wherein the glass fibers are bioactive glass fibers.

20. The method according to claim 4, wherein the glass composition melt exhibits a working window ΔT=T_{F}−T_{L}<330° C., wherein T_{F} is the fiber forming temperature at log(η) of 3.0 dPas and T_{L} is the liquidus temperature of the glass composition.
